(19) United States
(12) Patent Application Publication
(10) Pub. No.: US 2025/0370180 A1
(43) Pub. Date: Dec. 4, 2025

(54) OPTICAL FIBER AND METHOD OF FORMING THE SAME

(71) Applicant: Nanyang Technological University, Singapore (SG)

(72) Inventors: Seongwoo YOO, Singapore (SG); Charu GOEL, Singapore (SG)

(21) Appl. No.: 18/876,715

(22) PCT Filed: Jun. 28, 2023
(86) PCT No.: PCT/SG2023/050456

§ 371 Date: Dec. 19, 2024

(30) Foreign Application Priority Data
Jul. 28, 2022 (SG) 10202250614H

(51) Int. Cl. G02B 6/02

(52) U.S. Cl. CPC G02B 6/02342

(57) ABSTRACT

Various embodiments may provide an optical fiber. The optical fiber may include a medium having a first refractive index. The optical fiber may also include a first plurality of optical elements included in the medium, the first plurality of optical elements extending along a longitudinal length of the optical fiber, the first plurality of optical elements being solid rods having a second refractive index lower than the first refractive index. The optical fiber may further include a second plurality of optical elements included in the medium, the second plurality of optical elements extending along the longitudinal length of the optical fiber, the second plurality of optical elements being ring-shaped elements having a third refractive index higher than the first refractive index.

### CROSS-REFERENCE TO RELATED APPLICATION

This application claims the benefit of priority of Singapore Application No. 10202250614H filed Jul. 28, 2022, the contents of it being hereby incorporated by reference in its entirety for all purposes.

### TECHNICAL FIELD

Various embodiments of this disclosure may relate to an optical fiber. Various embodiments of this disclosure may relate to a method of forming an optical fiber.

### BACKGROUND

High-power fiber lasers delivering up to kilo-Watts (kWs) of optical power have revolutionized various scientific and industrial sectors. Fiber lasers are compact, portable and characterized by high brightness beam and excellent wall-plug efficiency. Large mode area (LMA) solid fibers form the core component of high-power fiber lasers. It is desirable for the lasing fiber to have a large mode area for better thermal management and to overcome nonlinear effects and modal instabilities at high powers. It is equally desirable to have single mode operation in these fibers because the presence of higher order modes (HOMs) deteriorates the laser beam quality.

Several fiber designs for LMA fibers have been developed in the last couple of decades, each surpassing the performance of others in certain aspects. Examples include double-clad LMA fibers, leakage channel fibers, large pitch fibers, Bragg fibers, multi-core fibers, chirally-coupled fibers etc. Some of these designs can provide mode areas in the range of 1500-3500 μm². Recently, a few all-solid anti-resonant fiber designs have been proposed that promise mode areas up to 5000 μm² with HOM suppression ratio of 20 dB/m for nearly single-mode operation over 100 nm bandwidth. FIG. 1 shows a traverse cross-sectional schematic of an all-solid anti-resonant optical fiber design, where high-index germanium (Ge)-doped rings confine light in the fundamental mode to the central core made of any suitable material (e.g. silica, fluoride, chalcogenide or tellurite glass), which could be doped with active ions (ytterbium/erbium/thulium) for lasing. However, since the anti-resonance guidance is weak, a typical solid anti-resonant fiber with 80 μm core diameter is expected to have propagation loss of ˜0.01 dB/m for the fundamental mode. Moreover, these fibers are extremely sensitive to bending and will have to be supported by a thick coating and kept straight in the form of a rod.

### SUMMARY

Various embodiments may provide an optical fiber. The optical fiber may include a medium having a first refractive index. The optical fiber may also include a first plurality of optical elements included in the medium, the first plurality of optical elements extending along a longitudinal length of the optical fiber, the first plurality of optical elements being solid rods having a second refractive index lower than the first refractive index. The optical fiber may further include a second plurality of optical elements included in the medium, the second plurality of optical elements extending along the longitudinal length of the optical fiber, the second plurality of optical elements being ring-shaped elements having a third refractive index higher than the first refractive index.

Various embodiments may relate to a method of forming an optical fiber. The method may include providing or forming a medium having a first refractive index. The method may also include providing or forming a first plurality of optical elements included in the medium, the first plurality of optical elements extending along a longitudinal length of the optical fiber, the first plurality of optical elements being solid rods having a second refractive index lower than the first refractive index. The method may further include providing or forming a second plurality of optical elements comprised in the medium, the second plurality of optical elements extending along the longitudinal length of the optical fiber, the second plurality of optical elements being ring-shaped elements having a third refractive index higher than the first refractive index.

### BRIEF DESCRIPTION OF THE DRAWINGS

In the drawings, like reference characters generally refer to the same parts throughout the different views. The drawings are not necessarily drawn to scale, emphasis instead generally being placed upon illustrating the principles of various embodiments. In the following description, various embodiments of the invention are described with reference to the following drawings.

FIG. 1 shows a traverse cross-sectional schematic of an all-solid anti-resonant optical fiber design, where high-index germanium (Ge)-doped rings confine light in the fundamental mode to the central core made of any suitable material (e.g. silica, fluoride, chalcogenide or tellurite glass), which could be doped with active ions (ytterbium/erbium/thulium) for lasing.

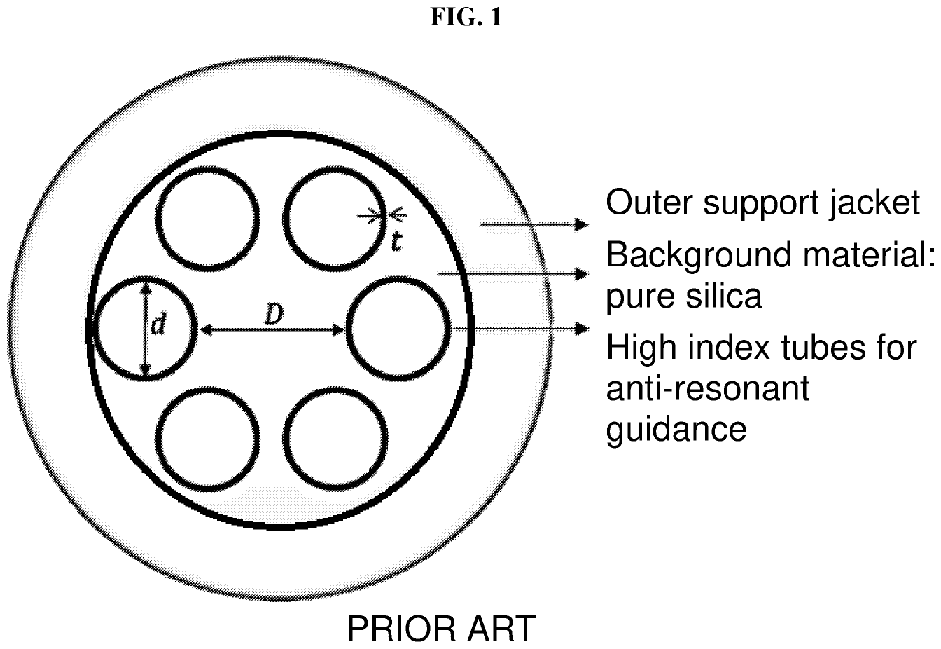

FIG. 2 is a general illustration of an optical fiber according to various embodiments.

FIG. 3 is a general illustration of a method of forming an optical fiber according to various embodiments.

FIG. 4 is a schematic showing a traverse cross-section of an optical fiber according to various embodiments.

FIG. 5A shows a plot of confinement loss (in decibels per meter or dB/m) as a function of wavelength (in micrometer or μm) illustrating the spectral variation of confinement loss for the fundamental mode (FM) and first higher order mode (1^{st} HOM) in the hybrid-guidance anti-resonant fiber (HGARF) according to various embodiments.

FIG. 5B shows a plot of bending-induced leakage loss (in decibels per meter or dB/m) as a function of wavelength (in micrometer or μm) illustrating the spectral variation of bending-induced leakage loss for the hybrid-guidance anti-resonant fiber (HGARF) according to various embodiments at a bend radius of 25 cm.

FIG. 6 is a schematic showing a traverse cross-section of an optical fiber according to various embodiments.

FIG. 7 is a schematic showing a traverse cross-section of an optical fiber according to various embodiments.

FIG. 8 is a schematic showing a traverse cross-section of an optical fiber according to various embodiments.

FIG. 9 is a schematic showing a traverse cross-section of an optical fiber according to various embodiments.

FIG. 10 is a schematic showing a traverse cross-section of an optical fiber according to various embodiments.

### DESCRIPTION

The following detailed description refers to the accompanying drawings that show, by way of illustration, specific details and embodiments in which the invention may be practiced. These embodiments are described in sufficient detail to enable those skilled in the art to practice the invention. Other embodiments may be utilized, and structural and logical changes may be made without departing from the scope of the invention. The various embodiments are not necessarily mutually exclusive, as some embodiments can be combined with one or more other embodiments to form new embodiments.

Features that are described in the context of an embodiment may correspondingly be applicable to the same or similar features in the other embodiments. Features that are described in the context of an embodiment may correspondingly be applicable to the other embodiments, even if not explicitly described in these other embodiments. Furthermore, additions and/or combinations and/or alternatives as described for a feature in the context of an embodiment may correspondingly be applicable to the same or similar feature in the other embodiments.

In the context of various embodiments, the articles “a”, “an” and “the” as used with regard to a feature or element include a reference to one or more of the features or elements.

In the context of various embodiments, the term “about” or “approximately” as applied to a numeric value encompasses the exact value and a reasonable variance, e.g. within 10% of the specified value.

As used herein, the term “and/or” includes any and all combinations of one or more of the associated listed items.

By “comprising” it is meant including, but not limited to, whatever follows the word “comprising”. Thus, use of the term “comprising” indicates that the listed elements are required or mandatory, but that other elements are optional and may or may not be present.

By “consisting of” is meant including, and limited to, whatever follows the phrase “consisting of”. Thus, the phrase “consisting of” indicates that the listed elements are required or mandatory, and that no other elements may be present.

Embodiments described in the context of one of the optical fibers are analogously valid for the other optical fibers. Similarly, embodiments described in the context of a method are analogously valid for an optical fiber, and vice versa.

Various embodiments may address one of more issues facing conventional optical fibers.

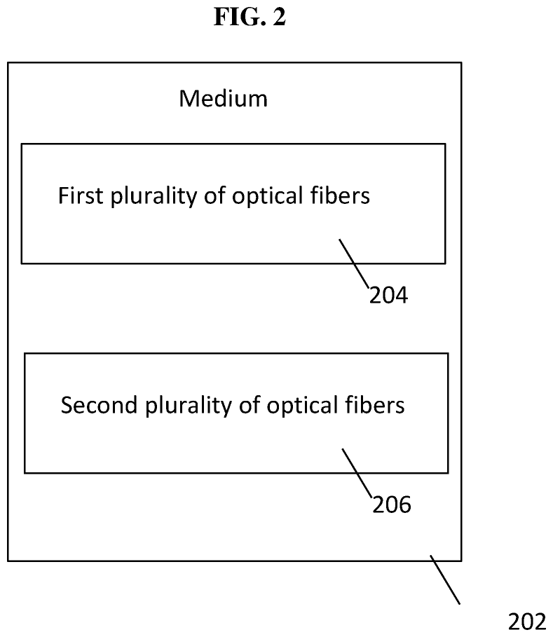

FIG. 2 is a general illustration of an optical fiber according to various embodiments. The optical fiber may include a medium 202 having a first refractive index. The optical fiber may also include a first plurality of optical elements 204 included in the medium 202, the first plurality of optical elements 204 extending along a longitudinal length of the optical fiber, the first plurality of optical elements 204 being solid rods having a second refractive index lower than the first refractive index. The optical fiber may further include a second plurality of optical elements 206 included in the medium 202, the second plurality of optical elements 206 extending along the longitudinal length of the optical fiber, the second plurality of optical elements 206 being ring-shaped elements having a third refractive index higher than the first refractive index.

In other words, various embodiments may relate to an optical fiber having a medium 202 including a first plurality of optical elements 204 and a second plurality of optical elements 206. The first plurality of optical elements 204 may be solid rods that have a refractive index that is lower than a refractive index of the medium 202. The second plurality of optical elements 206 may be ring-shaped elements that have a refractive index higher than a refractive index of the medium 202.

For avoidance of doubt, FIG. 2 seeks to illustrate some features of an optical fiber, and is not intended to limit, for instance, the shapes, sizes, orientation, arrangement etc. of the various components.

In various embodiments, the medium 202 may be made of a background material. The background material may have the first refractive index. The medium 202 may include a fiber core. The fiber core may be a central portion or region of the medium 202. The perimeter or circumference of the fiber core may be marked by or pass through the first plurality of optical elements 204. In terms of physical structure, the fiber core may not have a well-defined boundary from the rest of the medium 202. In various embodiments, the fiber core may be a solid core. In other words, the fiber may not have a hollow core.

In various embodiments, the first plurality of optical elements 204 may be configured to confine light using total internal reflection (TIR). In various embodiments, the second plurality of optical elements 206 may be configured to confine light using anti-resonant reflection.

The optical fiber may be referred to as an all-solid anti-resonant fiber. The optical fiber may be configured to operate in a single mode. Various embodiments may lower propagation loss and/or bending-induced loss by about one or two orders of magnitude.

As mentioned above, the second plurality of optical elements 206 may be ring-shaped elements. In the current context, a “ring-shaped element” may be a tube or an outer portion of a solid rod, wherein the ring-shaped element may be of any suitable (traverse) cross-sectional shape, such as a circle, an eclipse, or a pentagon. The cross-sectional shape may be defined by an outer perimeter of the ring-shaped element.

In various embodiments, each of the second plurality of optical elements 206 may be a tube including a portion of the medium or air. Generally speaking, each of the second plurality of optical elements 206, being ring-shaped elements, may enclose (across a traverse cross-section of the fiber) any suitable material lower than the third refractive index (i.e. the refractive index of the ring-shaped elements 206), such as air or a solid material such as the background material. In various embodiments, each of the second plurality of optical elements 206 may include or contain a further ring-shaped optical element. In various embodiments, each further ring-shaped optical element may be nested within a respective optical element of the second plurality of optical elements 206. Alternatively or additionally, the second plurality of optical elements 206 may be arranged as multiple rings or layers, e.g. around the fiber core. In various embodiments, a first group of the second plurality of optical elements 206 arranged as one ring or layer of the multiple rings or layers, and a second group of the second plurality of optical elements 206 arranged as another ring or layer of the multiple rings or layers may have a same refractive index. In various other embodiments, the first group of the second plurality of optical elements 206 arranged as one ring or layer of the multiple rings or layers, and the second group of the second plurality of optical elements 206 arranged as another ring or layer of the multiple rings or layers may have different refractive indexes. In various embodiments, the first group of the second plurality of optical elements 206 arranged as one ring or layer of the multiple rings or layers, and the second group of the second plurality of optical elements 206 arranged as another ring or layer of the multiple rings or layers may have a same wall thickness or diameter. In various other embodiments, the first group of the second plurality of optical elements 206 arranged as one ring or layer of the multiple rings or layers, and the second group of the second plurality of optical elements 206 arranged as another ring or layer of the multiple rings or layers may have different wall thicknesses or diameters.

As mentioned above, each of the second plurality of optical elements 206 may enclose the background material or any other solid material that has a refractive index lower than the third refractive index. In such an instance, each of the second plurality of optical elements 206 may be viewed as an outer portion of a (solid) rod, the outer portion surrounding an inner portion of the (solid) rod. The inner portion of the (solid) rod may have a refractive index lower than the third refractive index (i.e. the refractive index of the outer portion of the rod). For instance, the second plurality of optical elements 206 may be an outer portion of the (solid) rod including layers of high-index doped (of germanium (Ge), aluminum (Al) or phosphorous (P)) doped silica glass. The inner portion of the (solid) rod may include pure silica. In the current context, a “solid rod” may be an optical element of any suitable (traverse) cross-sectional shape, such as a circle, an eclipse, or a pentagon. The second plurality of optical elements 206 may be arranged in a continuous or discontinuous ring around the fiber core. In various embodiments, the second plurality of elements 206 may also form a continuous mesh around the fiber core.

In various embodiments, each of the first plurality of optical elements 204 may be nested within a respective optical element of the second plurality of optical elements 206.

In various embodiments, as mentioned above, each of the first plurality of optical elements 204 may be a (solid) rod. As mentioned above, In the current context, a “solid rod” may be an optical element of any suitable cross-sectional shape, such as a circle, an eclipse, or a pentagon. The first plurality of optical elements 204 may be arranged in a continuous or discontinuous ring around the fiber core. The first plurality of optical elements 204 may be arranged (in a continuous or discontinuous ring) along a circumference or perimeter of the fiber core of the medium 202.

In various embodiments, the first plurality of optical elements 204 may be arranged such that the first plurality of optical elements 204 breaks a circular symmetry of a cross-section of the optical fiber.

Generally speaking, the choice of materials for the medium 202, the first plurality of optical elements 204 and the second plurality of optical elements 206 may be such that the refractive index of the first plurality of optical elements 204 is lower than the refractive index of the medium 202, while the refractive index of the second plurality of optical elements 206 is higher than the refractive index of the medium 202. For instance, the medium 202 may include any suitable optical glass (such as pure silica, silicate glass, fluoride glass, chalcogenide glass, tellurite glass, sapphire crystal, sapphire glass etc.) that has the first refractive index. The first plurality of optical elements 204 may include any doped or undoped optical glass that has the second refractive index, i.e. a refractive index that is lower than the refractive index of the medium 202. For instance, the first plurality of optical elements 204 may include optical glass or silica doped with boron or fluorine. The second plurality of optical elements 206 may include any doped or undoped optical glass that has the third refractive index, i.e. a refractive index that is higher than the refractive index of the medium 202. For instance, each of the second plurality of optical elements 206 may include optical glass or silica doped with germanium, aluminum, or phosphorus which encloses an inner portion of background material 202 or any other solid material that has a refractive index lower than the third refractive index.

In various embodiments, the medium 202 may be undoped. The optical fiber may, for instance, be used as a passive fiber for beam delivery. In various other embodiments, the medium 202 may be doped with active ions, including one or more types of rare-earth ions, one or more types of transition metal ions or any combination of the abovementioned. The optical fiber may be used as an active fiber for lasing or amplification.

In various embodiments, the optical fiber may include an outer support jacket. The outer support jacket may surround the medium 202/fiber cladding (including the first plurality of optical elements 204 and the second plurality of optical elements 206). The outer support jacket may have any shape, for example, circular, hexagonal, octagonal etc. The outer support jacket may include a low refractive index silica, micro-structured air cladding, or low-index polymer coating, e.g. a material such as polyethylene (PE), polyvinyl chloride (PVC), or polyvinyl difluoride (PVDF). The outer support jacket may act as a second cladding for pump guidance in active-doped fibers.

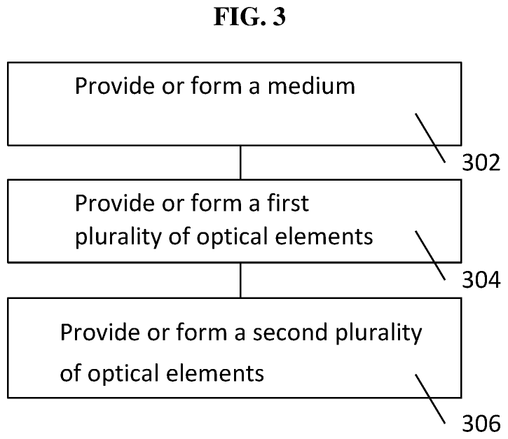

FIG. 3 is a general illustration of a method of forming an optical fiber according to various embodiments. The method may include, in 302, providing or forming a medium having a first refractive index. The method may also include, in 304, providing or forming a first plurality of optical elements included in the medium, the first plurality of optical elements extending along a longitudinal length of the optical fiber, the first plurality of optical elements being solid rods having a second refractive index lower than the first refractive index. The method may further include, in 306, providing or forming a second plurality of optical elements comprised in the medium, the second plurality of optical elements extending along the longitudinal length of the optical fiber, the second plurality of optical elements being ring-shaped elements having a third refractive index higher than the first refractive index.

In other words, the method for forming an optical fiber may include forming or providing the medium, the first plurality of optical elements and the second plurality of optical elements.

For avoidance of doubt, FIG. 3 is not intended to limit the sequence of the various steps. For instance, step 302 can occur before, at the same time, or after step 304.

In various embodiments, the first plurality of optical elements may be configured to confine light using total internal reflection (TIR). In various embodiments, the second plurality of optical elements may be configured to confine light using anti-resonant reflection.

In various embodiments, each of the second plurality of optical elements may be a tube. In various embodiments, each of the second plurality of optical elements may include a portion of the medium or air. Each of the second plurality of optical elements may include a further ring-shaped optical element.

In various embodiments, each of the second plurality of optical elements may be an outer portion of a (solid) rod, the outer portion surrounding an inner portion of the (solid) rod. The outer portion may have a refractive index lower than the third refractive index. Alternatively or additionally, the second plurality of optical elements may be arranged as multiple rings or layers, e.g. around the fiber core. In various embodiments, a first group of the second plurality of optical elements arranged as one ring or layer of the multiple rings or layers, and a second group of the second plurality of optical elements arranged as another ring or layer of the multiple rings or layers may have a same refractive index. In various other embodiments, the first group of the second plurality of optical elements arranged as one ring or layer of the multiple rings or layers, and the second group of the second plurality of optical elements arranged as another ring or layer of the multiple rings or layers may have different refractive indexes. In various embodiments, the first group of the second plurality of optical elements arranged as one ring or layer of the multiple rings or layers, and the second group of the second plurality of optical elements arranged as another ring or layer of the multiple rings or layers may have a same wall thickness or diameter. In various other embodiments, the first group of the second plurality of optical elements arranged as one ring or layer of the multiple rings or layers, and the second group of the second plurality of optical elements arranged as another ring or layer of the multiple rings or layers may have different wall thicknesses or diameters.

In various embodiments, as mentioned above, each of the first plurality of optical elements may be a rod. The first plurality of optical elements may be arranged (in a continuous or discontinuous ring) along a circumference or perimeter of a fiber core of the medium.

In various embodiments, each of the first plurality of optical elements may be nested within a respective optical element of the second plurality of optical elements.

In various embodiments, the first plurality of optical elements may be arranged such that the first plurality of optical elements breaks a circular symmetry of a cross-section of the optical fiber.

In various embodiments, the medium may include any suitable optical glass (such as pure silica, silicate glass, fluoride glass, chalcogenide glass, tellurite glass, sapphire crystal, sapphire glass etc.). The first plurality of optical elements may include any doped or undoped optical glass that has the second refractive index, i.e. a refractive index that is lower than the refractive index of the medium. For instance, the first plurality of optical elements may include optical glass or silica doped with boron or fluorine. The second plurality of optical elements may include any doped or undoped optical glass that has the third refractive index, i.e. a refractive index that is higher than the refractive index of the medium. For instance, the second plurality of optical elements may include optical glass or silica doped with germanium, aluminum, or phosphorus which encloses an inner portion of background material or any other solid material that has a refractive index lower than the third refractive index.

Large mode area (LMA) fibers form an important part of high-power fiber lasers. A large mode field area (MFA) is essential for mitigating nonlinearities and thermal effects while power scaling of laser output. It is equally desirable to have single-mode operation in these fibers to maintain a good beam quality and suppress transverse mode instabilities. Several effectively single-mode LMA fiber designs, including the leakage channel fiber, large pitch fiber, multicore fiber, chirally-coupled fiber, and all-solid photonic bandgap fiber have been reported in the past, and effective single mode operation over core size up to 50 μm has been demonstrated.

In recent years, research focus on micro-structured fibers has shifted from photonic bandgap fibers to a type of fibers called anti-resonant fibers (ARFs) because of their large transmission bandwidths, lower propagation loss, ease of fabrication, and efficient suppression of higher order modes (HOMs) over wide bandwidths. ARFs were initially proposed as hollow-core fibers for laser beam delivery, telecommunication, and nonlinear applications in gas-filled configurations. Recently, all-solid ARF designs have been proposed, in which light guidance in silica core, surrounded by high-index anti-resonant cladding, follows the same principles as in their hollow-core counterparts. These ARFs promise to achieve effective single mode operation for core sizes up to 100 μm with ultra-large MFAs ˜3000-5000 μm². These all-solid ARFs retain all the qualities of the hollow-core ARFs, such as simple cladding structure and large bandwidth of operation but suffer from comparatively higher confinement losses (CL), e.g., ˜10⁻² dB/m in single layer structures and ˜10⁻³ dB/m in dual-layer structures. This is due to a relatively low-refractive index contrast between silica core and germanium-doped anti-resonant rings. Another challenge associated with an increase in MFA is the high sensitivity to bend-induced losses and therefore, these ultra-LMA fibers need to be supported by thick outer jackets to form a rod-shape fiber.

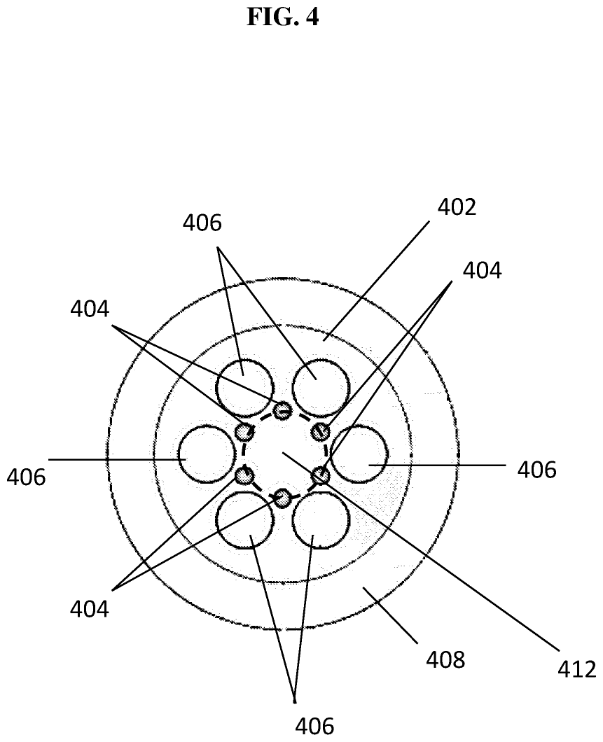

FIG. 4 is a schematic showing a traverse cross-section of an optical fiber according to various embodiments. The optical fiber may include a medium 402 having a first refractive index. The optical fiber may also include a first plurality of optical elements 404 included in the medium 402, the first plurality of optical elements 404 extending along a longitudinal length of the optical fiber, the first plurality of optical elements 404 being solid rods having a second refractive index lower than the first refractive index. The optical fiber may further include a second plurality of optical elements 406 included in the medium 402, the second plurality of optical elements 406 extending along the longitudinal length of the optical fiber, the second plurality of optical elements 406 being ring-shaped elements having a third refractive index higher than the first refractive index. The optical fiber may additionally include an outer support jacket 408 surrounding the medium 402. As shown in FIG. 4, the first plurality of optical elements 404 may be arranged in a first ring, and the second plurality of optical elements 406 may be arranged in a second ring. FIG. 4 shows the first plurality of optical elements 404 arranged as an inner ring and the second plurality of optical elements 406 arranged as an outer ring. However, it may be envisioned that in various other embodiments, the first plurality of optical elements 404 may be arranged as an outer ring, while the second plurality of optical elements 406 may be arranged as an inner ring. FIG. 4 also shows that each optical element of the first plurality of optical elements 404 may be arranged between two neighboring optical elements of the second plurality of optical elements 406. The fiber core 412 may be a central portion or region of the medium 402. The boundary of the fiber core 412 may be indicated by a circumference of a circle passing through the first plurality of optical elements 404 as indicated by the dashed line in FIG. 4. The fiber core 412 may be the circle with the circumference passing through the first plurality of optical elements 404. Physically, the fiber core 412 may not have a well-defined boundary from the rest of the medium 402.

In various embodiments, the medium 402 may not be doped with active ions, and the optical fiber may act as a passive fiber. In various other embodiments, the medium 402 may be doped with active ions, and the optical fiber may be used as an active fiber suitable for lasing or amplification.

The first plurality of optical elements 404 may be solid rods of any suitable traverse cross-sectional shape. The first plurality of optical elements 404 may, for instance, be boron-doped or fluorine-doped rods or elements. The first plurality of optical elements 404 may be arranged in a continuous or discontinuous ring in the medium 402 along the perimeter or circumference of the fiber core 412 to provide light guidance by total internal reflection (TIR). The second plurality of optical elements 406 may be anti-resonant elements in the form of tubes (of any suitable traverse cross-sectional shape) or outer portions/claddings of solid rods. The anti-resonant elements 406 may guide light by the principle of inhibited coupling and anti-resonance. Examples of second plurality of optical elements 406 in the form of outer portions of solid rods may for instance be an outer layer of germanium-doped, aluminum doped or phosphorous doped glass around an all-solid silica rod. Such structure may be fabricated by (1) high-index glass deposition on pure silica rods using outer-vapor deposition method, or (2) depositing high-index glass inside a silica tube using modified chemical vapor deposition and collapsing this tube around a pure silica rod, or (3) using a stack and draw technique.

Various embodiments may relate to a hybrid light guidance scheme in an all-solid anti-resonant fiber. Various embodiments may relate to an all-solid large mode area anti-resonant fiber (LMA ARF). The optical fiber may be modified such that it relies on a combination of index guidance (via total internal reflection (TIR)) and anti-resonance guidance. The optical fiber may be a hybrid-guidance anti-resonant fiber (HGARF). Various embodiments may reduce confinement losses (CL) and bending-induced losses by at least an order of magnitude.

The anti-resonance guidance may be supported by arrangement of the second plurality of optical elements 406 around the fiber core 412 (as viewed across a traverse cross-section of the fiber), and may help to maintain broadband single mode operation with ultra large mode area. The index guidance may be enabled by spatial distribution of refractive index perturbation around the fiber core 412.

In one implementation, the medium 402 may be pure silica (nominal refractive index or nominal n₁=1.45). The second plurality of optical elements 406 may be anti-resonant elements in the form of germanium (Ge)-doped silica rings (nominal refractive index or nominal n₂=1.48). The wall thickness (t) of the rings 406 is chosen to be 2.6 μm to ensure that the peak wavelength of Yb-emission (1030 nm) lies in the center of the anti-resonant band. The core diameter D is chosen to be 80 μm and the inner diameter d of the cladding rings 406 is optimized to be 0.74 D to ensure that the first higher order mode (HOM) is phase-matched to a lossy, cladding mode and suffers high propagation loss. The first plurality of optical elements 404 may be low-index (boron or fluorine doped) rods interspersed in the medium 402 to provide an added TIR-based guidance to the mode field. The rods 404 may be strategically placed to cover the gaps between the anti-resonant elements 406 to suppress bending-induced leakage loss (or bend loss). The index difference between these rods 404 and pure silica is assumed to be 5×10⁻³.

Detailed numerical analysis of the fiber carried out based on a core diameter of 80 μm may be optimized for operation in 1 μm wavelength range. The wavelength range of operation in an all-solid ARF may be decided solely by the wall thickness of the anti-resonant elements 406 and therefore the design principles may be extended to any wavelengths within a material transmission window including the 2 μm wavelength range.

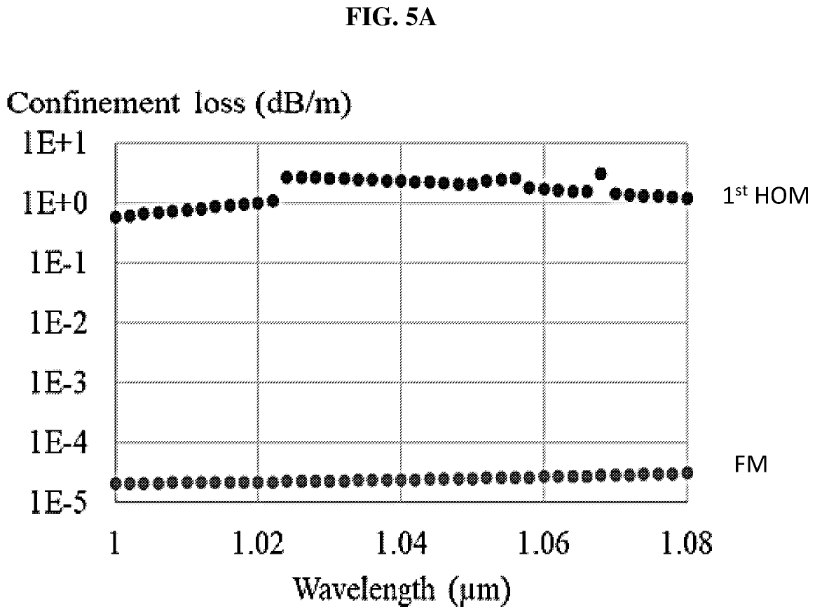

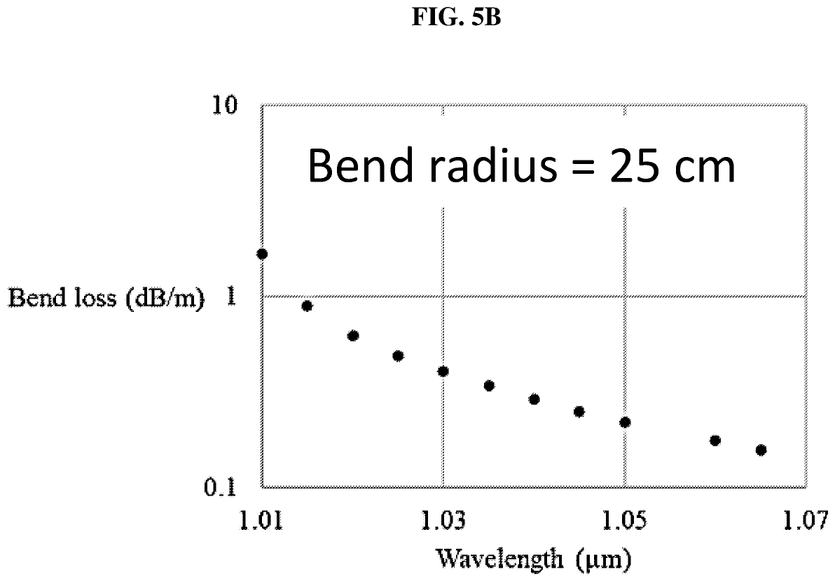

Detailed simulations based on full-vector finite element method using COMSOL Multiphysics software reveal that the confinement loss (CL) in this design is an order of magnitude lower and the bending loss is lower by two orders of magnitude in dB scale, as compared to a pristine anti-resonant fiber having identical fiber parameters, but without the low-index rods. FIG. 5A shows a plot of confinement loss (in decibels per meter or dB/m) as a function of wavelength (in micrometer or μm) illustrating the spectral variation of confinement loss for the fundamental mode (FM) and first higher order mode (1 st HOM) in the hybrid-guidance anti-resonant fiber (HGARF) according to various embodiments. The TIR guidance may be weak and may not mask the filtering of HOMs by resonant coupling to the cladding modes, ensuring a higher order mode extinction ratio (HOMER).

FIG. 5B shows a plot of bending-induced leakage loss (in decibels per meter or dB/m) as a function of wavelength (in micrometer or μm) illustrating the spectral variation of bending-induced leakage loss for the hybrid-guidance anti-resonant fiber (HGARF) according to various embodiments at a bend radius of 25 cm.

It is shown herein that ultra large fundamental mode area (>3000 μm²) may be achieved with this design, while maintaining effective single mode guidance. The hybrid light guidance mechanism may reduce the modal confinement loss and the bend-induced leakage loss by orders of magnitude.

The introduction of low-index optical elements 404 may increase confinement in the medium 402, and thereby decrease propagation loss by at least an order of magnitude. The low-index optical elements 404 may significantly reduce bending loss in the optical fibers.

The asymmetrical arrangement of the low-index optical elements 404 may also open up design space for high birefringence and/or polarization filter designs.

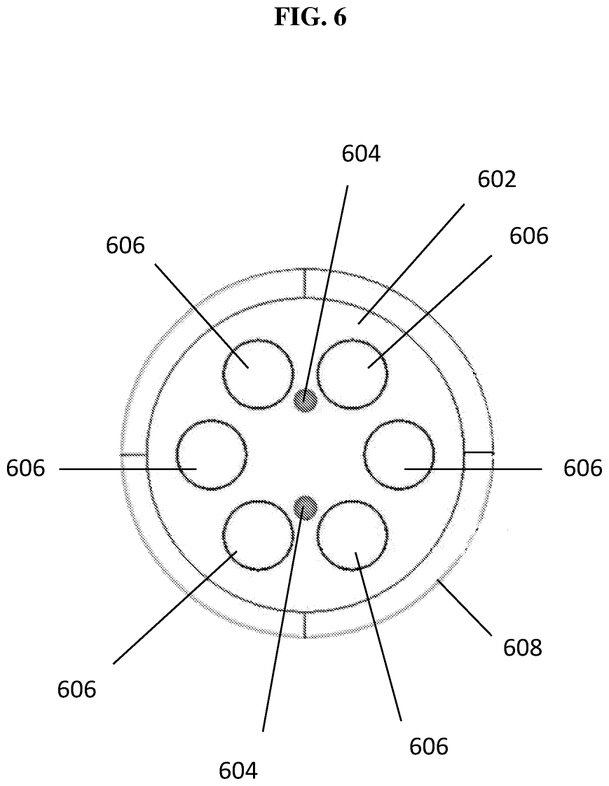

FIG. 6 is a schematic showing a traverse cross-section of an optical fiber according to various embodiments. The optical fiber may include a medium 602 having a first refractive index. The optical fiber may also include a first plurality of optical elements 604 included in the medium 602, the first plurality of optical elements 604 extending along a longitudinal length of the optical fiber, the first plurality of optical elements 604 being solid rods having a second refractive index lower than the first refractive index. The optical fiber may further include a second plurality of optical elements 606 included in the medium 602, the second plurality of optical elements 606 extending along the longitudinal length of the optical fiber, the second plurality of optical elements 606 being ring-shaped elements having a third refractive index higher than the first refractive index. The optical fiber may additionally include an outer support jacket 608 surrounding the medium 602. As shown in FIG. 6, the first plurality of optical elements 604 may be arranged such that the first plurality of optical elements 604 break a circular symmetry of a cross-section of the optical fiber.

Stress induced by asymmetrically arranged optical elements or rods 604 (that break the circular symmetry of a fiber cross-section) of different refractive index material can cause high birefringence in an all-solid optical fiber, which is desirable to maintain a single polarization mode. For avoidance of doubt, “asymmetrically arranged” or “asymmetrically arrangement” may mean that the circular symmetry of the structure is broken so that two perpendicular polarizations may depict different behavior.

An asymmetrical arrangement of optical elements or rods 604 may be expected to lead to high birefringence and hence polarization maintaining property of the optical fiber. Moreover, an asymmetric distribution of low-index optical elements or rods 604 may cause one of the orthogonal linear polarizations to filter out by virtue of high confinement loss and/or bend loss. Accordingly, the optical fiber may support only one of the orthogonal linear polarizations, and maybe an ideal candidate for high-power polarized fiber lasers, which find applications in harmonic generation, parametric conversion, coherent detection, and coherent and spectral beam etc.

The design principles as described herein may be extended to multi-layers nested, multi-layers outer-ring or conjoined tube fiber structures for distinct optical functions/features.

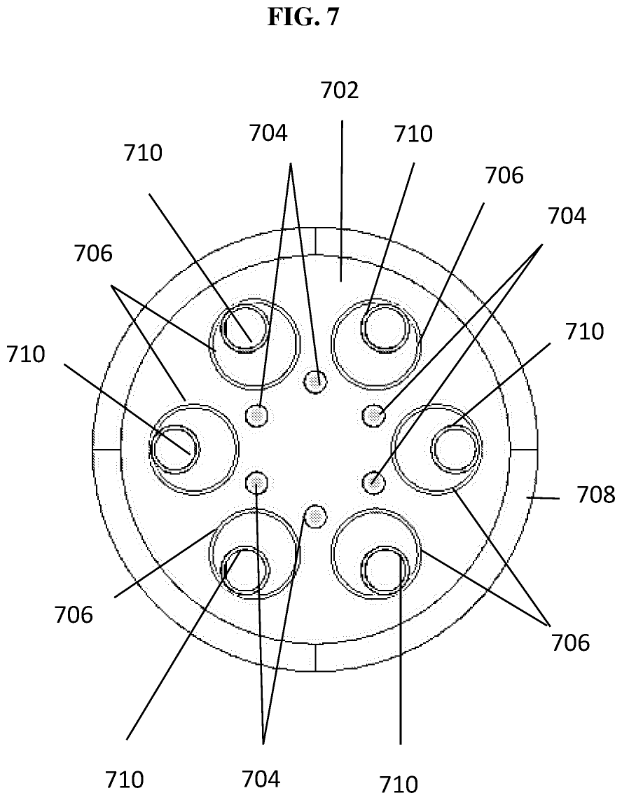

FIG. 7 is a schematic showing a traverse cross-section of an optical fiber according to various embodiments. The optical fiber may include a medium 702 having a first refractive index. The optical fiber may also include a first plurality of optical elements 704 included in the medium 702, the first plurality of optical elements 704 extending along a longitudinal length of the optical fiber, the first plurality of optical elements 704 being solid rods having a second refractive index lower than the first refractive index. The optical fiber may further include a second plurality of optical elements 706 included in the medium 702, the second plurality of optical elements 706 extending along the longitudinal length of the optical fiber, the second plurality of optical elements 706 being ring-shaped elements having a third refractive index higher than the first refractive index. The optical fiber may additionally include an outer support jacket 708 surrounding the medium 702. Each of the second plurality of optical elements 706 may include a further ring-shaped optical element 710. As shown in FIG. 7, each further ring-shaped optical element 710 may be nested within a corresponding or respective optical element of the second plurality of optical elements 706. The further ring-shaped optical element 710 may be smaller (i.e. have a smaller diameter) than the corresponding or respective optical element of the second plurality of optical elements 706. While FIG. 7 shows a portion of the further ring-shaped optical element 710 in contact with a portion of the corresponding or respective optical element of the second plurality of optical elements 706, the further ring-shaped optical element 710 may be nested at any suitable position within the corresponding or respective optical element of the second plurality of optical elements 706.

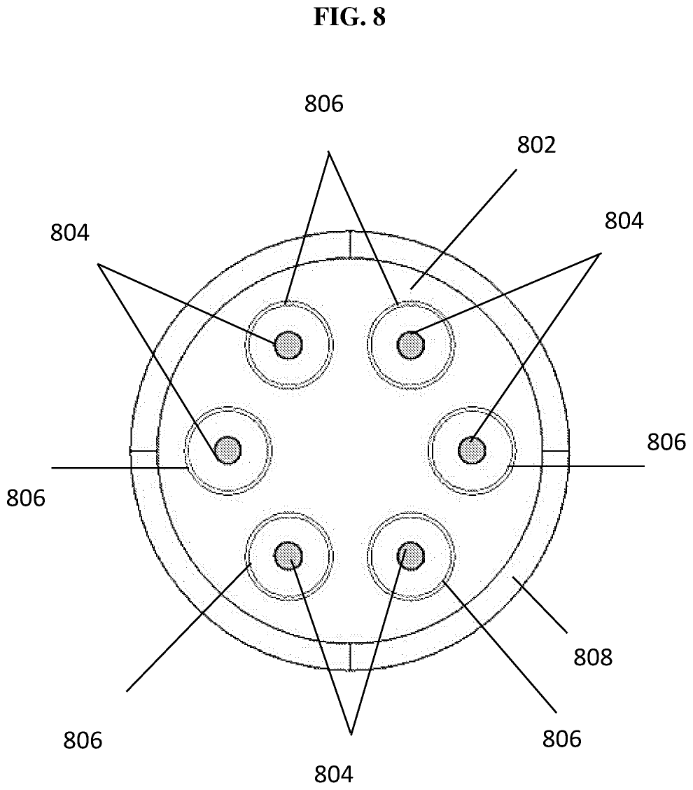

FIG. 8 is a schematic showing a traverse cross-section of an optical fiber according to various embodiments. The optical fiber may include a medium 802 having a first refractive index. The optical fiber may also include a first plurality of optical elements 804 included in the medium 802, the first plurality of optical elements 804 extending along a longitudinal length of the optical fiber, the first plurality of optical elements 804 being solid rods having a second refractive index lower than the first refractive index. The optical fiber may further include a second plurality of optical elements 806 included in the medium 802, the second plurality of optical elements 806 extending along the longitudinal length of the optical fiber, the second plurality of optical elements 806 being ring-shaped elements having a third refractive index higher than the first refractive index. The optical fiber may additionally include an outer support jacket 808 surrounding the medium 802. Each of the first plurality of optical elements 804 may be nested within a respective optical element of the second plurality of optical elements 806. Each of the first plurality of optical elements 804 may be located at any suitable position within the respective optical element of the second plurality of optical elements 806.

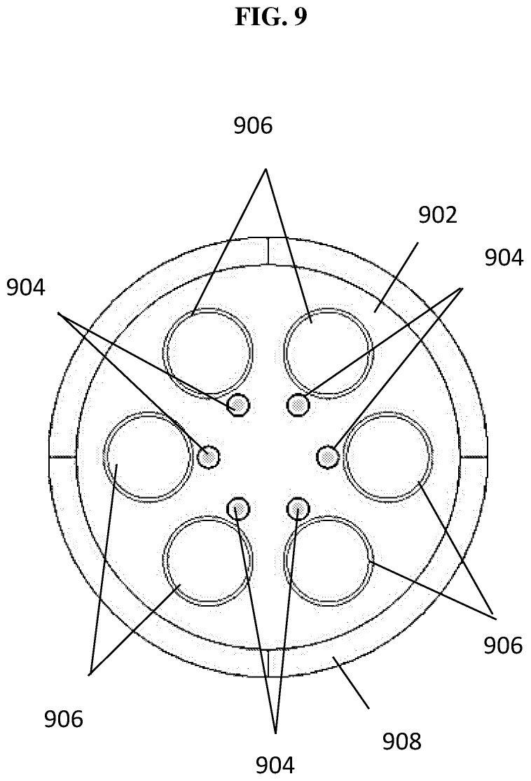

FIG. 9 is a schematic showing a traverse cross-section of an optical fiber according to various embodiments. The optical fiber may include a medium 902 having a first refractive index. The optical fiber may also include a first plurality of optical elements 904 included in the medium 902, the first plurality of optical elements 904 extending along a longitudinal length of the optical fiber, the first plurality of optical elements 904 being solid rods having a second refractive index lower than the first refractive index. The optical fiber may further include a second plurality of optical elements 906 included in the medium 902, the second plurality of optical elements 906 extending along the longitudinal length of the optical fiber, the second plurality of optical elements 906 being ring-shaped elements having a third refractive index higher than the first refractive index. The optical fiber may additionally include an outer support jacket 908 surrounding the medium 902. Each of the first plurality of optical elements 904 may be in contact with a respective optical element of the second plurality of optical elements 906.

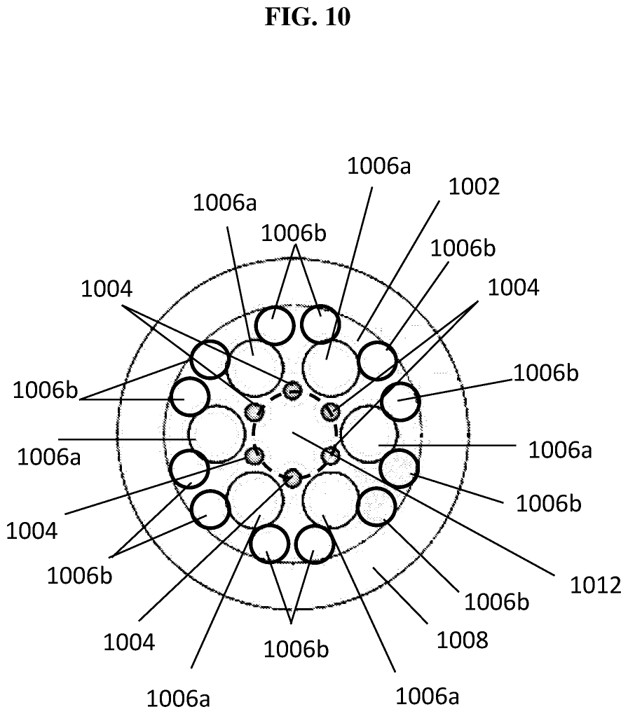

FIG. 10 is a schematic showing a traverse cross-section of an optical fiber according to various embodiments. The optical fiber may include a medium 1002 having a first refractive index. The optical fiber may also include a first plurality of optical elements 1004 included in the medium 1002, the first plurality of optical elements 1004 extending along a longitudinal length of the optical fiber, the first plurality of optical elements 1004 being solid rods having a second refractive index lower than the first refractive index. The optical fiber may further include a second plurality of optical elements 1006a, 1006b included in the medium 1002, the second plurality of optical elements 1006a, 1006b extending along the longitudinal length of the optical fiber, the second plurality of optical elements 1006a, 1006b being ring-shaped elements having a third refractive index higher than the first refractive index. As shown in FIG. 10, the second plurality of optical elements 1006a, 1006b may be arranged as two layers or rings around the fiber core 1012. The first group of the second plurality of optical elements 1006a may form the first layer or ring, while the second group of the second plurality of optical elements 1006b may form the second layer or ring. While FIG. 10 shows that the second group of the second plurality of optical elements 1006b is smaller (or has a smaller diameter) than the first group of the second plurality of optical elements 1006a, it may also be envisioned that the second group 1006b is larger or of the same size (or has either a bigger or same diameter) as the first group 1006a. In various embodiments, the first group of the second plurality of optical elements 1006a and the second group of the second plurality of optical elements 1006b may have a same refractive index. In various other embodiments, the first group of the second plurality of optical elements 1006a and the second group of the second plurality of optical elements 1006b may have different refractive indexes. In various embodiments, the first group of the second plurality of optical elements 1006a and the second group of the second plurality of optical elements 1006b may have a same wall thickness. In various other embodiments, the first group of the second plurality of optical elements 1006a and the second group of the second plurality of optical elements 1006b may have different wall thicknesses. The optical fiber may additionally include an outer support jacket 1008 surrounding the medium 1002.

1. An optical fiber comprising:
a medium having a first refractive index;
a first plurality of optical elements comprised in the medium, the first plurality of optical elements extending along a longitudinal length of the optical fiber, the first plurality of optical elements being solid rods having a second refractive index lower than the first refractive index; and
a second plurality of optical elements comprised in the medium, the second plurality of optical elements extending along the longitudinal length of the optical fiber, the second plurality of optical elements being ring-shaped elements having a third refractive index higher than the first refractive index.

2. The optical fiber according to claim 1, wherein the first plurality of optical elements is configured to confine light using total internal reflection.

3. The optical fiber according to claim 1, wherein the second plurality of optical elements is configured to confine light using anti-resonant reflection.

4. The optical fiber according to claim 1, wherein each of the second plurality of optical elements comprises a portion of the medium or air.

5. The optical fiber according to claim 1, wherein each of the second plurality of optical elements comprises a further ring-shaped optical element.

6. The optical fiber according to claim 1, wherein each of the second plurality of optical elements is an outer portion of a further solid rod, the outer portion surrounding an inner portion of the further solid rod; and
wherein the inner portion of the further solid rod has a refractive index lower than the third refractive index.

7. The optical fiber according to claim 1, wherein the second plurality of optical elements is arranged as multiple rings or layers.

8. The optical fiber according to claim 7, wherein a first group of the second plurality of optical elements arranged as one ring or layer of the multiple rings or layers, and a second group of the second plurality of optical elements arranged as another ring or layer of the multiple rings or layers may have a same refractive index.

9. The optical fiber according to claim 7, wherein a first group of the second plurality of optical elements arranged as one ring or layer of the multiple rings or layers, and a second group of the second plurality of optical elements arranged as another ring or layer of the multiple rings or layers may have different refractive indexes.

10. The optical fiber according to claim 7, wherein a first group of the second plurality of optical elements arranged as one ring or layer of the multiple rings or layers, and a second group of the second plurality of optical elements arranged as another ring or layer of the multiple rings or layers may have a same wall thickness or diameter.

11. The optical fiber according to claim 7, wherein a first group of the second plurality of optical elements arranged as one ring or layer of the multiple rings or layers, and a second group of the second plurality of optical elements arranged as another ring or layer of the multiple rings or layers may have different wall thicknesses or diameters.

12. The optical fiber according to claim 1, wherein the first plurality of optical elements is arranged in a continuous or discontinuous ring along a perimeter or circumference of a fiber core of the medium.

13. The optical fiber according to claim 1, wherein each of the first plurality of optical elements is nested within a respective optical element of the second plurality of optical elements.

14. The optical fiber according to claim 1, wherein the first plurality of optical elements is arranged such that the first plurality of optical elements breaks a circular symmetry of a cross-section of the optical fiber.

15. The optical fiber according to claim 1, wherein the medium comprises any suitable optical glass having the first refractive index;
wherein the first plurality of optical elements comprises any suitable doped or undoped glass having the second refractive index; and
wherein the second plurality of optical elements comprises any doped or undoped glass having the third refractive index.

16. A method of forming an optical fiber, the method comprising:
providing a medium having a first refractive index;
providing a first plurality of optical elements comprised in the medium, the first plurality of optical elements extending along a longitudinal length of the optical fiber, the first plurality of optical elements being solid rods having a second refractive index lower than the first refractive index; and
providing a second plurality of optical elements comprised in the medium, the second plurality of optical elements extending along the longitudinal length of the optical fiber, the second plurality of optical elements being ring-shaped elements having a third refractive index higher than the first refractive index.

17. The method according to claim 16, wherein the first plurality of optical elements is configured to confine light using total internal reflection.

18. The method according to claim 16, wherein the second plurality of optical elements is configured to confine light using anti-resonant reflection.

19. The method according to claim 16, wherein each of the second plurality of optical elements comprises a portion of the medium or air.

20. The method according to claim 16, wherein each of the second plurality of optical elements comprises a further ring-shaped optical element.

21-30. (canceled)
